(19) United States
(12) Patent Application Publication
(10) Pub. No.: US 2004/0067066 A1
(43) Pub. Date: Apr. 8, 2004

(54) Optical transmission system using nonlinear material

(75) Inventor: Katsumi Uesaka, Atherton, CA (US)

Correspondence Address: MCDERMOTT, WILL & EMERY, 18191 VON KARMAN AVE., SUITE 500, IRVINE, CA, 92612-7108, US

(73) Assignee: Innovation Core SEI, Inc.

(21) Appl. No.: 10/302,851

(22) Filed: Nov. 25, 2002

Related U.S. Application Data
(60) Provisional application No. 60/415,429, filed on Oct. 3, 2002.

(51) Int. Cl. H04B 10/00; H04B 10/12; H04B 10/18

(52) U.S. Cl. 398/194; 398/200; 398/201

(57) ABSTRACT

An optical transmission system comprising an input for accepting a signal, a laser diode within an optical transmitter for signal modulation and/or for signal amplification, a nonlinear material for compensating signal distortions, a transmission fiber for signal transmission, and an optical receiver for receiving the signal. The optical transmission system may include a multiple of input signals, each input signal fed into one of a multiple of optical transmitters. Each of the multiple of optical transmitters is coupled to a nonlinear material. The output of each nonlinear material is coupled to an optical multiplexer for multiplexing the multiple of input signals into a multiplexed signal for transmission through a transmission fiber. The multiplexed signal is then de-multiplexed into a multiple of de-multiplexed signals, each de-multiplexed signal corresponding to each of the multiple of input signals, and each de-multiplexed signal is received by one of a multiple of receivers.

### RELATED APPLICATIONS

This application claims priority of patent application Ser. No. ______, filed with the United States Patent Office on Nov. 20, 2002 entitled An Optical Transmitter Using Nonlinear Material And Method invented by Katsumi Uesaka and of Provisional Patent Application No. 60/415,429, filed on Oct. 3, 2002.

### INCORPORATION BY REFERENCE

This application hereby incorporates by reference in their entirety a) an application filed with the United States Patent Office on Sep. 23, 2002, U.S. patent application Ser. No. 10/251,836 entitled An Optical Transmitter Using Highly Nonlinear Fiber and Method invented by Katsumi Uesaka and b) an application filed with the United States Patent Office on Nov. 20, 2002, U.S. patent application Ser. No. ______ entitled An Optical Transmitter Using Nonlinear Material and Method invented by Katsumi Uesaka

### FIELD OF THE INVENTION

The field of the present invention relates generally to optical fiber (lightwave) communication systems. More particularly, the invention relates to an optical transmission system using a nonlinear material (such as a fiber, film, a bulk structure or a waveguide) for signal distortion compensation.

### BACKGROUND INFORMATION

There is a growing interest in high speed optical data transmission, particularly for data rates greater than 10 Gbps. To accommodate this high speed data transmission, cost effective means of lightwave modulation have been explored. One such method is the addition of an external modulator to the optical transmitter. However, external modulators add expense, complexity and/or volume to the communication system and require additional amplifiers in the transmission line to compensate for the limited output power of the optical transmitter. Hence, an attractive alternative to external modulation is to incorporate direct modulation in a high power optical transmitter. One such direct modulation technique is to incorporate a directly modulated laser diode system (such as a distributed feedback laser diode “DFB-LD”) within the optical transmitter as shown in FIG. 1.

The advantages of the directly modulated laser diode system include its small size, low cost, low driving voltage and high output power characteristics. With direct modulation of a laser diode, an amplification-free design is achievable for long transmission distances. However, the disadvantage of this conventional system is the frequency chirp characteristic of the directly modulated laser diode system which distorts the signal and significantly limits the maximum achievable transmission distance. As shown in the example given in FIG. 1, a conventional optical transmitter may include a laser driver 2 to amplify and/or reshape the input signal 6 and a distributed feedback laser diode 3 for modulation. The signal 6 is transmitted through a single mode fiber 4 and received by an optical receiver 5. The conventional system would suffer from the disadvantage noted above.

One way to analyze data transmission systems is through a generated display called an eye pattern. An eye pattern may be created by applying the received signal to the vertical deflection plates of an oscilloscope. Additionally, a periodic sawtooth wave is applied to the horizontal deflection plates. The waveforms are then translated into a one interval display on the oscilloscope, resulting in an eye pattern similar to the one illustrated in FIG. 2. An eye pattern may also be synthesized via computer simulation. The interior region of the eye pattern is called the eye opening. The larger the width of the eye opening, the greater the time interval over which the received wave can be sampled without error from intersymbol interference. Additionally, the slope of the eye opening defines the sensitivity of the system to timing error while the height of the eye opening defines the margin over noise. See “Communication Systems”, Simon Haykin, Second Edition, pp. 496-497.

In this regard, FIG. 2 illustrates 10 Gbps output waveform signal quality after 40 km fiber transmission for the conventional optical receiver 5 by means of its simulated eye pattern discussed above. It is clear from FIG. 2 that the low eye opening height and timing jitter spreading in the eye pattern indicates that poor bit error rate performance will occur over this distance and at this data rate. Thus, the conventional solution of the directly modulated laser diode optical transmitter has created a problem of degradation of signal quality over long distance and high speed transmission.

Conventional solutions to this problem have taken three approaches. First, a dispersion compensation fiber (DCF) (including negative dispersion fiber) can be added to the transmission line to compensate the signal distortion. However, to be an effective solution, the length of the DCF needs to be matched to the length of the conventional fibers already installed. Thus, customizing the length of the DCF for each existing fiber system is required. An alternative is to reinstall all new fibers in the transmission path with negative dispersion fiber. Either alternative is expensive. Second, installing a narrow optical bandpass filter at the output of the distributed feedback laser (DFB-LD) will suppress the frequency chirping of the DFB-LD. But, the narrow bandwidth requirement needed by the bandpass filter increases the sensitivity to temperature variations and causes passband stability problems. Additionally, a narrow bandwidth limits the quantity of data transmission which is not desirable. Third, regenerators may be added to the transmission path to overcome the dispersion penalty. However, this solution greatly increases cost, complexity and/or volume to the transmission system.

FIGS. 3-8 refer to the characteristics and performance of an optical transmitter using highly nonlinear fiber as discussed in U.S. patent application Ser. No. 10/251,836, the subject matter of which has been incorporated herein by reference. In this previously filed application, a highly nonlinear fiber is used within the optical transmitter to compensate for frequency chirping.

FIG. 3 is a simulated eye pattern which illustrates 10 Gbps output waveform signal quality after 40 km fiber transmission measured at an optical receiver. The transmission system utilizes a highly nonlinear fiber within the optical transmitter for frequency chirp compensation. In contrast to FIG. 2, the eye pattern shown in FIG. 3 is much clearer, indicative of less signal distortion measured at the optical receiver. FIGS. 4-8 are characteristics and performance graphs of the same optical transmission system which uses a highly nonlinear fiber for frequency chirp compensation. FIG. 4 is a power profile versus time graph of a distributed feedback laser diode output waveform simulated at a bit rate of 10 Gbps. FIG. 5 is a frequency chirp profile versus time graph. The upper graph displays the chirping characteristics versus time at the output of a distributed feedback laser diode. The lower graph displays the chirping characteristics versus time after compensation is introduced by the highly nonlinear fiber. Comparison of the upper and lower graphs indicates that a nonlinear material (a highly nonlinear fiber in the present case) effectively reduces the frequency chirp to minimize transmitter signal distortion. Similarly, FIG. 6 illustrates the bit error rate (BER) performance and FIG. 7 illustrates the power penalty [dB] characteristics at a BER=10⁻⁹ of different transmission scenarios that utilize the self phase modulation of a nonlinear material (a highly nonlinear fiber in the present case). The graphs of FIGS. 6 and 7 illustrate the improved communication performance after application of the pre-chirping technique using a nonlinear material in the transmitter. FIG. 8 illustrates that the performance characteristics of a transmission system with a nonlinear material (a highly nonlinear fiber in the present case) is not sensitive to pseudo random bit sequence lengths.

While the invention disclosed therein produces a good quality signal at low cost, alteration to the optical transmitter to include a nonlinear material within the transmitter is needed. Therefore, it would be desirable to use a conventional optical transmitter with either directly modulated laser or externally modulated laser in an optical transmission system which optimizes the transmitter frequency chirping.

### SUMMARY OF THE INVENTION

The present invention is an optical signal transmission system which includes a nonlinear material (implemented as, but not limited to, a fiber, a film, a bulk structure or a waveguide) to compensate for frequency chirping of a transmitter, or generate proper frequency chirping for fiber transmission.

According to one aspect of the invention, the optical transmission system of the present invention includes an optical transmitter with a laser diode for electrical to optical signal conversion, a nonlinear material coupled to the transmitter, where the nonlinear material compensates for signal distortions caused by the laser diode and/or by the transmission fiber; and a transmission fiber coupled to the nonlinear material for communicating the signal to an optical receiver.

In another aspect of the invention, the present invention is an optical transmission system which includes an optical transmitter with a distributed feedback laser diode for electrical to optical signal conversion, a nonlinear material (which is anti-reflection coated) coupled to the transmitter for compensating for signal distortions caused by the distributed feedback laser diode, at least two variable optical attenuators for power adjustment, and a transmission fiber coupled to one of the two variable optical attenuators, the transmission fiber for communicating the signal to an optical receiver.

In yet another aspect of the invention, the present invention is an optical transmission system which includes a multitude of optical transmitters with each optical transmitter including a laser diode for electrical to optical signal conversion and each optical transmitter being coupled to a nonlinear material for compensating signal distortions, a multiplexer which is coupled to the nonlinear materials for multiplexing the signals into a multiplexed signal, a transmission fiber coupled to the multiplexer for communicating the multiplexed signal to a de-multiplexer, the de-multiplexer performing de-multiplexing on the multiplexed signal to generate a multitude of de-multiplexed signals, and a multitude of optical receivers, each optical receiver coupled to the de-multiplexer for receiving one of the de-multiplexed signals.

In yet another aspect of the invention, the present invention is method for transmitting a multitude of input signals by generating the input signals, modulating the input signals, compensating for signal distortion by passing each of the input signals through separate nonlinear materials with the quantity of input signals equaling the quantity of nonlinear materials, multiplexing the input signals into a multiplexed signal and transmitting the multiplexed signal to a de-multiplexer, and de-multiplexing the multiplexed signal into a multitude of de-multiplexed signals with the multitude of de-multiplexed signals corresponding to the multitude of input signals on a one-to-one basis.

### BRIEF DESCRIPTION OF THE DRAWINGS

FIG. 1 is a block diagram of a conventional direct modulation optical transmission system.

FIG. 2 illustrates the simulated 10 Gbps receiver output waveform eye pattern after 40 km fiber transmission using the conventional optical transmission system.

FIG. 3 illustrates the simulated 10 Gbps receiver output waveform eye pattern after 40 km fiber transmission using an optical transmission system with a highly nonlinear fiber at its output.

FIG. 4 is a power profile versus time graph of a laser diode output waveform simulation.

FIG. 5 is a frequency chirp profile versus time graph of a laser diode output waveform simulation comparing the effects of no chirping compensation versus with chirping compensation as introduced by a highly nonlinear dispersion shifted fiber.

FIG. 6 illustrates the bit error rate (BER) characteristics for three transmission scenarios utilizing the self phase modulation of a highly nonlinear dispersion shifted fiber.

FIG. 7 illustrates the power penalty characteristics of a highly nonlinear dispersion shifted fiber for two single mode fiber lengths at a bit error rate (BER) of 10⁻⁹.

FIG. 8 illustrates the bit error rate (BER) characteristics for various pseudo random bit sequence (PRBS) lengths using highly nonlinear dispersion shifted fiber.

FIG. 9 is a logarithmic plot of an effective length profile versus nonlinear index coefficient.

FIG. 10 is a block diagram of a first embodiment of an optical transmission system in accordance with the present invention.

FIG. 11 is a simulated frequency chirp profile versus time graph comparing the effects of no chirping compensation versus with chirping compensation as introduced by a nonlinear material.

FIG. 12 illustrates the power penalty characteristics of a nonlinear material for two single mode fiber lengths at a bit error rate (BER) of 10⁻⁹.

FIGS. 13 is a block diagram of another embodiment of an optical transmission system in accordance with the present invention.

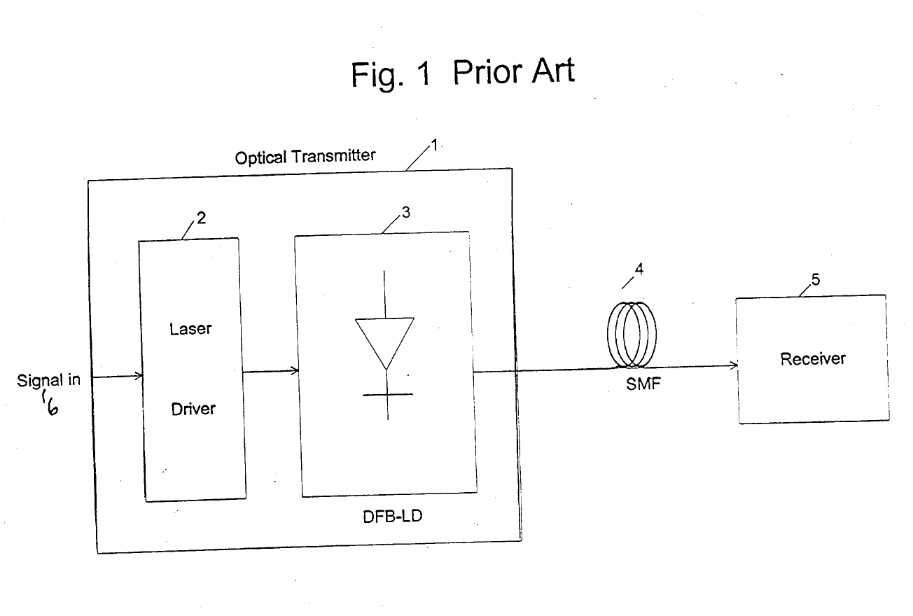

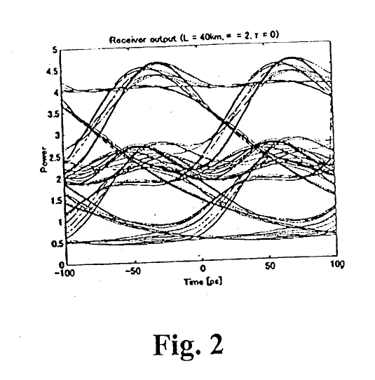

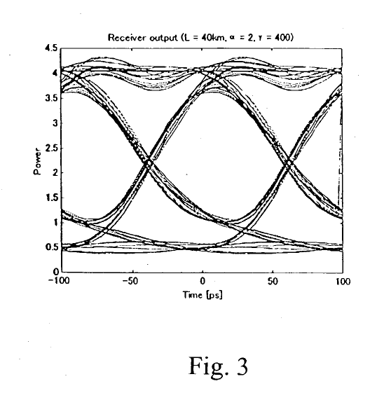

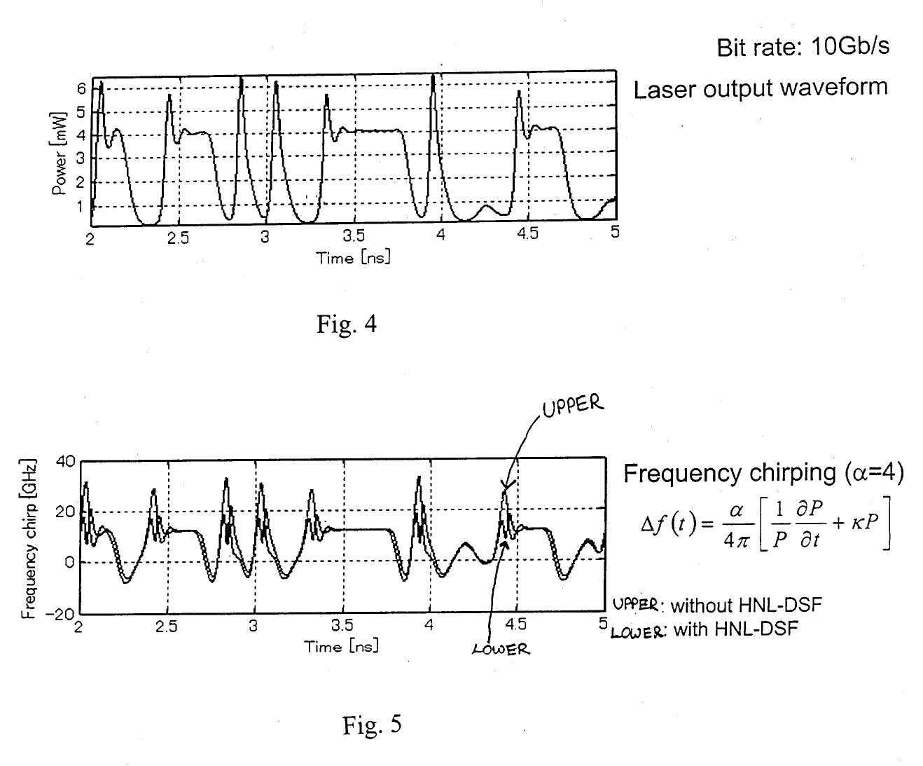

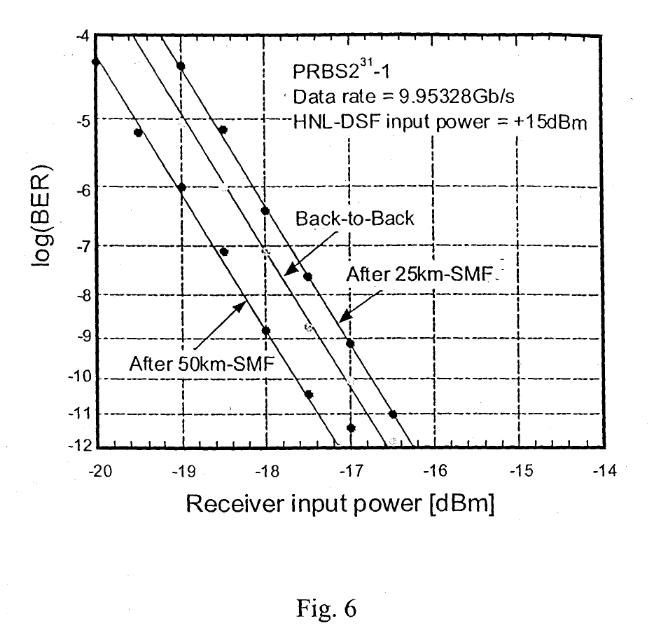

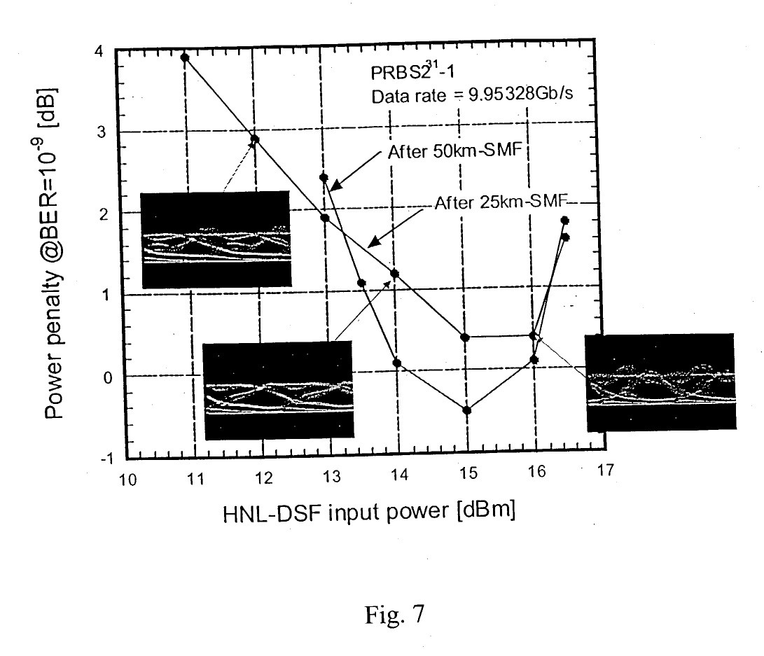

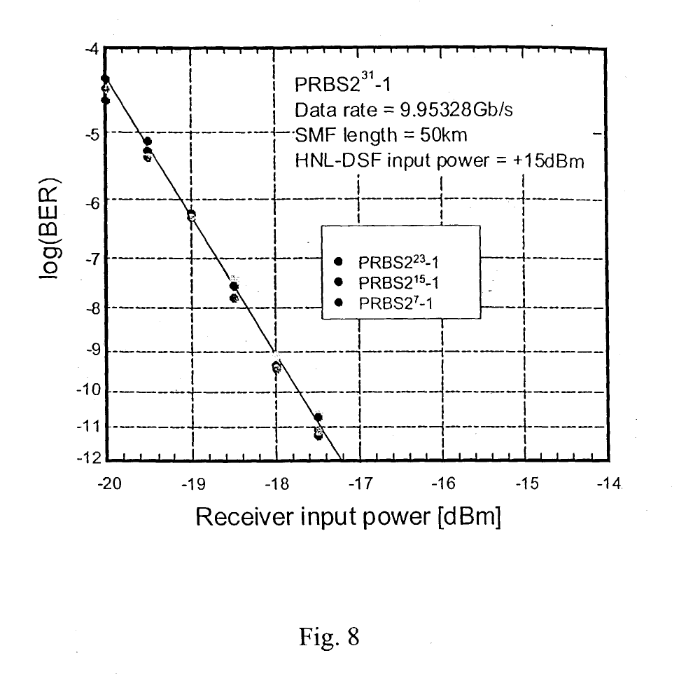

### DETAILED DESCRIPTION OF THE INVENTION

The present invention is directed to optical transmission system that uses a nonlinear material (implemented as, but not limited to, a fiber, a film, a bulk structure or a waveguide) to compensate for or modify transmitter frequency chirping and improve signal transmission performance.

The subject matters of U.S. patent application Ser. No. 10/251,836 entitled An Optical Transmitter Using Highly Nonlinear Fiber and Method, by Katsumi Uesaka, filed on Sep. 23, 2002, and U.S. patent application Ser. No. ______ entitled An Optical Transmitter Using Nonlinear Material And Method, by Katsumi Uesaka, filed on Nov. 20, 2002 are hereby incorporated by reference in their entirety.

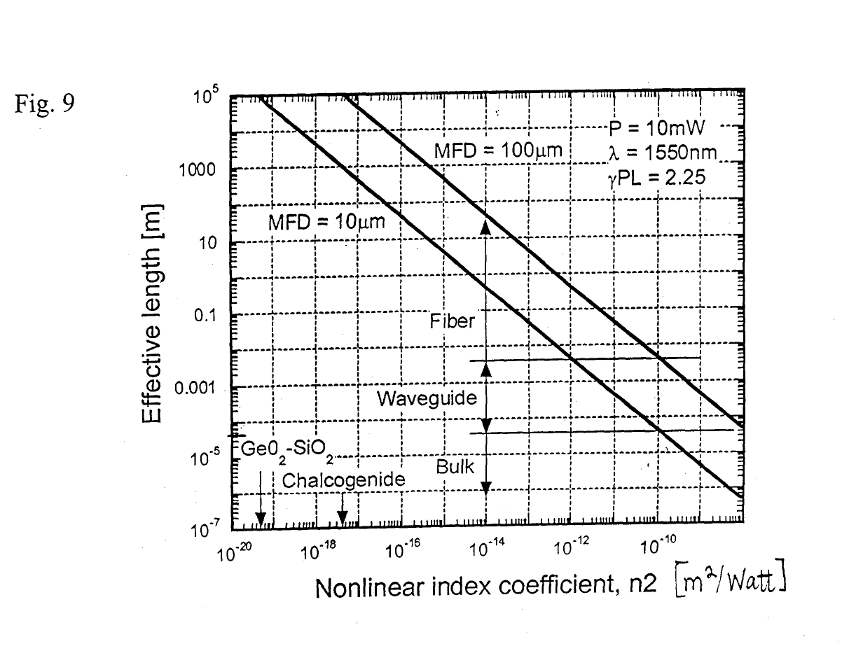

FIG. 9 is a logarithmic plot of an effective length profile versus nonlinear index coefficient. From experimentation using highly nonlinear dispersion shifted fiber (HNL-DSF), the required nonlinear phase shift γPL_{eff} for compensating the frequency chirping of a directly modulated laser is estimated to be around 2-3 radians. For a typical external modulator, the γPL_{eff} value is around 0.5 to 0.75 radians. Here, γ [W⁻¹m⁻¹] is the nonlinear coefficient, P [W] is the launched optical power into the nonlinear material, and L_{eff} [m] is the effective length of the nonlinear material.

Relationship between nonlinear index coefficient n2 and nonlinear coefficient γ is given by

$$γ = \frac{2 π}{λ} \frac{n 2}{{A}_{eff}} \qquad ( 1 )$$

where λ is the wavelength of the laser beam, and A_{eff} is the effective area of the beam.

By using mode field diameter (MFD), A_{eff} is given by

A_{eff}=π(MFD/2)² (2)

Relationship among power P, effective length L_{eff}, and nonlinear index coefficient n2 (after substituting the definitions of γ and A_{eff}) is

$$γ {PL}_{eff} = \frac{2 π}{λ} \frac{n 2}{{π ( MFD / 2 )}^{2}} \cdot P \cdot {L}_{eff} = \frac{8}{λ} \frac{n 2}{{MFD}^{2}} \cdot P \cdot {L}_{eff} \qquad ( 3 )$$

Since it is already known that the required γPL_{eff} is around 2-3 radians (for directly modulated lasers), the relationship between n2 and L_{eff} is known. In FIG. 9, P=10 mW, λ=1550 nm, and γPL_{eff}=2.25.

The relationship between effective length (L_{eff}) and actual length L is given by equation (4):

$${L}_{eff} = \frac{1}{α} [ 1 - exp ( - α \cdot L ) ] \qquad ( 4 )$$

In equation (4), α is the material loss and is in dimensions of 1/m, α [m⁻¹]. From equation (3), it is clear that a larger n2 allows a shorter L_{eff} for a constant γPL value. Similarly, a smaller MFD allows a shorter L_{eff}, or a smaller MFD allows a smaller n2.

FIG. 9 illustrates the dependency of effective length of a nonlinear material (which has, at least, third order nonlinear susceptibility χ³), which can be in the form of a fiber, a waveguide, a bulk structure, including a film, on the nonlinear index coefficient based on mode field diameters (“MFD”). Typically, the nonlinear index coefficient of a Chalcogenide nonlinear fiber is between 10⁻¹⁸ and 10⁻¹⁷ m²/Watt. This translates into an effective length of approximately 1000 meters with a MFD of about 10 μm and greater effective length with increasing MFD. Similarly, a Germanium doped Silicon (GeO₂—SiO₂) nonlinear fiber requires an effective length of approximately 10⁵ meters for an MFD of about 10 μm and greater effective length with increasing MFD. Alternatively, the effective length versus nonlinear index coefficient profile of a nonlinear material such as a film or a bulk structure is shown in FIG. 9 by the area labeled “bulk.” A typical nonlinear index coefficient of a nonlinear film or a nonlinear bulk structure is about 10⁻¹⁰ m²/Watt, and with a MFD of about 10 μm, the effective length is about 10⁻⁵ m. Typically, the thickness of a film is about 10 μm, and the thickness of a bulk structure is greater than 10 μm. A preferred thickness of the bulk structure is between 100 μm and 1 mm. Similarly, the effective length versus nonlinear index coefficient profile of the nonlinear material such as a waveguide is shown in FIG. 9 by the area labeled “waveguide.” A typical nonlinear index coefficient of a nonlinear waveguide is between 10⁻¹² and 10⁻¹⁰ m²/Watt and with a MFD of about 10 μm, the effective length is about 10⁻³-10⁻⁵ m.

The addition of a nonlinear material (such as a nonlinear fiber, a nonlinear film, a nonlinear bulk structure or a nonlinear waveguide) with the above-described characteristics in an optical transmission system is effect in compensating for frequency chirping of a transmitter, or generating proper frequency chirping for transmitted signal, and thus improves signal quality at the received end.

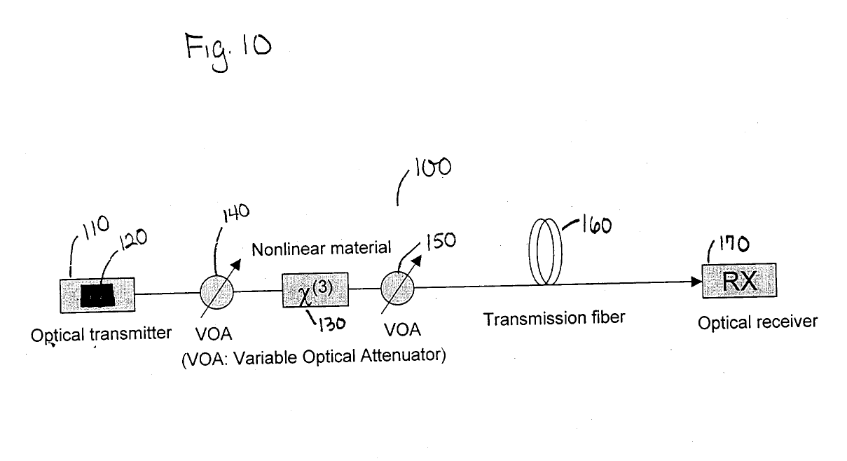

FIG. 10 is a block diagram of an embodiment of an optical transmission system in accordance with the present invention. In a first embodiment, the optical transmission system 100 comprises an optical transmitter 110 which includes a laser driver/distributed feedback laser diode unit 120 for signal modulation and/or signal amplification. The output of the optical transmitter 110 is coupled to a nonlinear material 130. The nonlinear material 130 is coupled to a transmission fiber 160 and input into an optical receiver 170. (The laser unit 120 may include an external modulator. In that case, the nonlinear material will be used to generate proper frequency chirping in its output.)

In another embodiment, variable optical attenuators 140, 150 may be added to the transmission system 100. One attenuator may be used to adjust the nonlinear phase shift in the nonlinear material 130 while another attenuator may be placed to adjust the power input to the transmission fiber 160. The nonlinearity characteristic of the nonlinear material 130 is desirable for compensating unwanted frequency chirping, or generate proper frequency chirping. The nonlinear material 130 introduces a negative frequency chirp versus the transmitted optical pulse power level; therefore, it can compensate the positive frequency chirping of the directly modulated distributed feedback laser diode 120, or generate proper negative chirping for external modulated signal. In one preferred embodiment, the nonlinear material is a film with an effective length of about 10⁻⁵ meters and a nonlinear index coefficient of about 10⁻¹⁰ m²/Watt at an MFD of 10 μm.

In other preferred embodiments, the nonlinear material is a nonlinear bulk structure, a nonlinear waveguide or a nonlinear fiber which may be used in place of a nonlinear film to achieve comparable frequency chirping compensation. In one preferred embodiment, the nonlinear material is a bulk structure with an effective length of about 10⁻⁵ meters and a nonlinear index coefficient of about 10⁻¹⁰ m²/Watt at an MFD of 10 μm. In another preferred embodiment, the nonlinear material is a waveguide with an effective length of about 10⁻³ meters and a nonlinear index coefficient of about 10/⁻¹² m²/Watt at an MFD of 10 μm. In yet another preferred embodiment, the nonlinear material is a fiber with an effective length of about 0.5 to 1 meter and a nonlinear index coefficient of about 10⁻¹⁴ m²/Watt at an MFD of 10 μm. Although the preferred combinations of effective length and nonlinear index coefficient of several types of nonlinear materials are mentioned, it will be appreciated that they are presented only as examples and the invention is not limited thereby.

The laser driver/diode unit 120 amplifies and/or reshapes input electrical signal and converts it to optical signal. The modulated optical signal is then output from the optical transmitter 110 and then passed through to the remainder of the transmission system 100. In one embodiment, the remainder of the transmission system 100 includes a nonlinear material 130, transmission fiber 160 and an optical receiver 170 to receive the transmitted signal. Frequency chirping is a byproduct of the directly modulated distributed feedback laser diode 120 which results in transmitter signal distortion. However, in the optical transmission system of the present invention, the nonlinear material 130 compensates for the frequency chirp generated by the laser driver/diode unit 120. Similarly, in the case for external modulated transmitter, proper negative chirping introduced by the nonlinear material will compensate the signal distortion caused by fiber dispersion. As a result, a less distorted signal is passed through the transmission fiber 140 to the optical receiver 150.

In the transmission system 100, with the use of the nonlinear material 130 (fiber, film, bulk structure or waveguide) having the above-described nonlinearity characteristics, one can expect improved transmission performance (i.e., less signal distortion). As an example a nonlinear fiber is used within an optical transmitter to compensate for frequency chirping. The resulting clear eye pattern, the bit error rates, the power penalty performances and binary pattern length dependencies of this configuration are disclosed in the application filed with the United States Patent Office on Sep. 23, 2002, U.S. patent application Ser. No. 10/251,836 entitled An Optical Transmitter Using Highly Nonlinear Fiber and Method invented by Katsumi Uesaka. Although the arrangement of the present invention differs from that shown in U.S. patent application Ser. No. 10/251,836, with regards to the placement of the nonlinear material 130, similar improved signal quality results such as in eye pattern, the bit error rates, the power penalty performances and binary pattern length characteristics are expected.

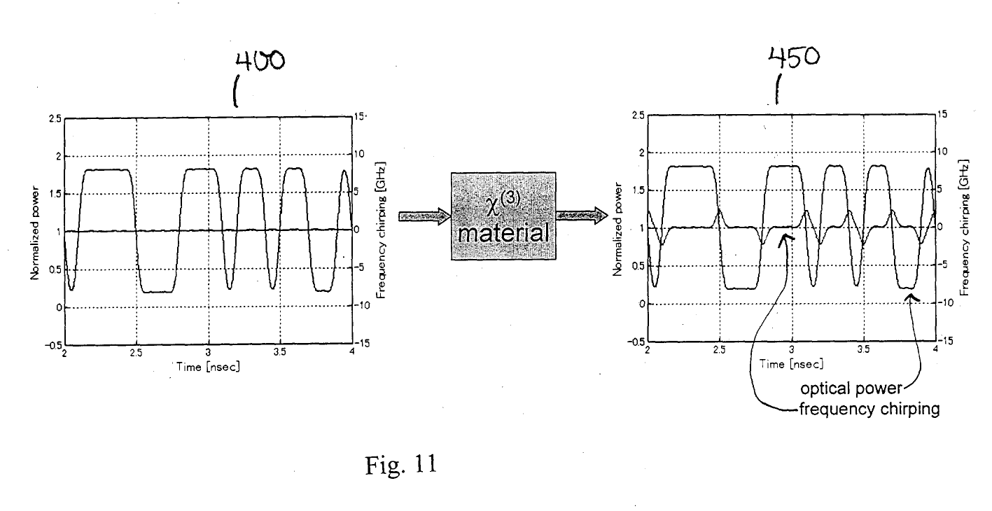

FIG. 11 explains the frequency chirping induced by the nonlinear material 130. Suppose we input an optical signal without frequency chirping into the nonlinear material 130, which is illustrated in the left side 400 of FIG. 11, the output optical signal from the nonlinear material includes negative chirp as illustrated in the right side 450 of FIG. 11. Since laser diode 120 has intrinsic positive chirp characteristics, this positive chirp can be compensated by the negative frequency chirp induced in the nonlinear material 130 in the transmission system 100. (Also see FIG. 5.) For long haul optical transmissions, slightly negative chirping is preferred. Therefore, we can apply a nonlinear material 130 to compensate for signal distortions for either an internal modulation system or for an external modulation system. In the case of an external modulation system, zero-chirped external modulated signal can be pre-chirped adequately by the nonlinear material 130. In the present invention as shown in FIG. 10, the block 130 is the nonlinear material 130 which can be implemented in a variety of placements along the transmission system 100 and in its preferred embodiment with a fiber, a film, a bulk structure or a waveguide with the nonlinearity characteristics discussed above. Further, in one embodiment, the nonlinear material 130 is coated with an anti-reflection (“AR”) coating.

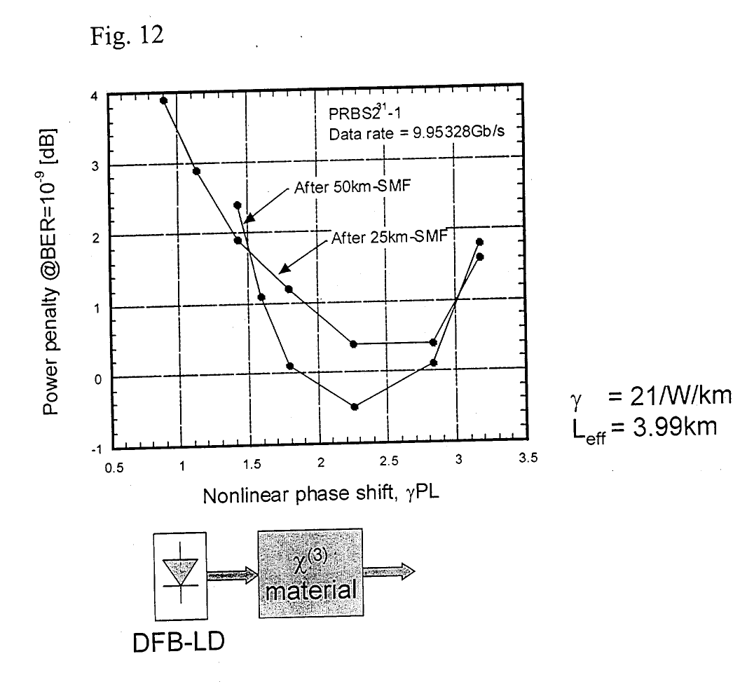

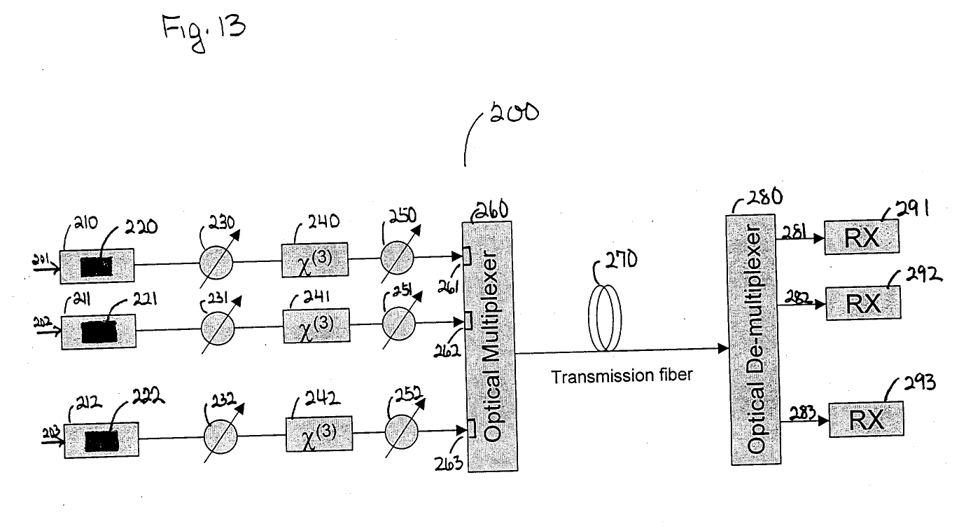

The power penalty characteristics of the nonlinear material 130 of the present invention shown in FIG. 10 (which is tested in a laboratory setup) is illustrated in FIG. 12. FIG. 12 illustrates the power penalty [dB] characteristics of the nonlinear material 130 for two transmission fiber lengths (25 km single mode fiber and 50 km single mode fiber), at an operating point of 10⁻⁹ bit error rate, versus nonlinear phase shift, γPL. The 50 km SMF fiber length has a lower power penalty than the 25 km SMF fiber length near the optimum nonlinear phase shift 2.25 radians (at the input of the nonlinear material). Power penalty is referenced relative to the back-to-back link scenario. FIG. 12 also indicates the increased power penalty sensitivity for over pre-chirped signals versus under pre-chirped signals. To improve bit error rate performance, a forward error correction (FEC) technique (known to one of ordinary skill in the art) is combined with the pre-chirping technique of the present invention to correct transmitted signal errors. In one embodiment, the combination of forward error correction technique and the pre-chirping technique of the present invention improves communication performance.

In FIG. 13 another embodiment of the present invention is shown. The transmission system 200 comprises a plurality of optical transmitters 210, 211, 212 with each optical transmitter 210, 211, 212 having a laser driver/distributed feedback laser diode unit 220, 221, 222, which also may include an external modulator. A plurality of input signals 201, 202, 203 are input into the optical transmitter. The output of each optical transmitter 210, 211, 212 is separately coupled to a separate nonlinear material 240, 241, 242. The output of each of the nonlinear material 240, 241, 242 feeds into a plurality of inputs 261, 262, 263 of an optical multiplexer 260. Once inside the optical multiplexer 260, the plurality of signals 201, 202, 203 are multiplexed. The resulting multiplexed signal 271 (not shown) is output from the optical multiplexer 260 and transmitter through a transmission fiber 270 to an optical demultiplexer 280. At the optical demultiplexer 280, the multiplexed signal 271 is demultiplexed into a plurality of corresponding signals 281, 282, 283 which correspond to the plurality of input signals 201, 202, 203. Each corresponding signals 281, 282, 283 is then received by a corresponding optical receiver 291, 292, 293. Although only three optical transmitters with three nonlinear material and three optical receivers are shown, it is clear to one skilled in the art that present invention may accommodate an arbitrary plurality of transmitters and receiver links and is thus not limited to the system depicted in FIG. 13.

In one embodiment, the nonlinear materials 240, 241, 242 are coated with anti-reflection (“AR”) coatings. In another embodiment, variable optical attenuators 230, 231, 232, 250, 251, 252 are added to the transmission system (as shown in FIG. 13) for adjusting the nonlinear phase shift in the nonlinear materials 240, 241, 242 and/or for adjusting the power input to the transmission fiber 270. Although the placement of the variable optical attenuators 230, 231, 232, 250, 251, 252 are shown in one configuration in FIG. 13, it is clear that other placements in the transmission system 200 (based on design choices) are possible.

Although preferred arrangements of an optical transmission system utilizing a nonlinear material are shown in FIGS. 10 and 13, it should be noted that other arrangements (including additional units) are possible for achieving the desired signal performance and (other variations which are within the scope of the invention as defined in the claims) will be apparent to those skilled in the art.

What is claimed is:

1. An optical transmission system for communicating a signal comprising:
an optical transmitter having a transmitter input for inputting the signal, a transmitter output and a laser diode for signal conversion;
a nonlinear material coupled to the transmitter output, wherein the nonlinear material compensates for signal distortions; and
a transmission fiber coupled to the nonlinear material for communicating the signal to an optical receiver.

2. The optical transmission system of claim 1 wherein the laser diode is a distributed feedback laser diode.

3. The optical transmission system of claim 1 wherein the optical transmitter includes an external modulator for signal modulation.

4. The optical transmission system of claim 1 further comprising a first variable optical attenuator for power adjustment in the transmission system, the first variable optical attenuator being coupled to the transmitter output.

5. The optical transmission system of claim 4 further comprising a second variable optical attenuator for power adjustment in the transmission system, the second variable optical attenuator being coupled to the nonlinear material and the multiplexer.

6. The optical transmission system of claim 1 further comprising at least two variable optical attenuators for power adjustment in the transmission system, the at least two variable optical attenuators being coupled to the transmitter output.

7. The optical transmission system of claim 1 wherein the nonlinear material is a nonlinear film.

8. The optical transmission system of claim 7 wherein the nonlinear film has a nonlinear index coefficient greater than 10⁻¹⁰ m²/Watt.

9. The optical transmission system of claim 7 wherein the nonlinear film has a nonlinear index coefficient of about 10⁻¹⁰ m²/Watt.

10. The optical transmission system of claim 7 wherein the nonlinear film has a nonlinear index coefficient of about 10⁻¹⁰ m²/Watt at a mode field diameter of 10 μm and an input power to the nonlinear film of 10 m Watt.

11. The optical transmission system of claim 7 wherein the nonlinear film has a nonlinear index coefficient greater than 10⁻¹⁰ m²/Watt at a mode field diameter of 100 μm and an input power to the nonlinear film of 10 mWatt.

12. The optical transmission system of claim 1 wherein the nonlinear material is a nonlinear bulk structure.

13. The optical transmission system of claim 12 wherein the nonlinear bulk structure has a nonlinear index coefficient greater than 10⁻¹⁰ m²/Watt.

14. The optical transmission system of claim 12 wherein the nonlinear bulk structure has a nonlinear index coefficient of about 10⁻¹⁰ m²/Watt.

15. The optical transmission system of claim 12 wherein the nonlinear bulk structure has a nonlinear index coefficient of about 10⁻¹⁰ m²/Watt at a mode field diameter of 10 μm and an input power to the nonlinear bulk structure of 10 m Watt.

16. The optical transmission system of claim 12 wherein the nonlinear bulk structure has a nonlinear index coefficient greater than 10⁻¹⁰ m²/Watt at a mode field diameter of 100 μm and an input power to the nonlinear bulk structure of 10 m Watt.

17. The optical transmission system of claim 1 wherein the nonlinear material is a nonlinear waveguide.

18. The optical transmission system of claim 17 wherein the nonlinear waveguide has a nonlinear index coefficient greater than 10⁻¹² m²/Watt.

19. The optical transmission system of claim 17 wherein the nonlinear waveguide has a nonlinear index coefficient between 10⁻¹² m²/Watt and 10⁻¹⁰ m²/Watt.

20. The optical transmission system of claim 17 wherein the nonlinear waveguide has a nonlinear index coefficient between 10⁻¹² m²/Watt and 10⁻¹⁰ m²/Watt at a mode field diameter of 10 μm and an input power to the nonlinear waveguide of 10 m Watt.

21. The optical transmission system of claim 17 wherein the nonlinear waveguide has a nonlinear index coefficient greater than 10⁻¹⁰ m²/Watt at a mode field diameter of 100 μm and an input power to the nonlinear waveguide of 10 m Watt.

22. The optical transmitter of claim 1 wherein the nonlinear material is a nonlinear fiber.

23. The optical transmitter of claim 22 wherein the nonlinear fiber has a nonlinear index coefficient greater than 10⁻¹⁴ m²/Watt.

24. The optical transmitter of claim 22 wherein the nonlinear fiber has a nonlinear index coefficient of about 10⁻¹⁴ m²/Watt.

25. The optical transmitter of claim 22 wherein the nonlinear fiber has a nonlinear index coefficient of 10⁻¹⁴ m²/Watt at a mode field diameter of 10 μm and an input power to the nonlinear fiber of 10 μm Watt.

26. The optical transmitter of claim 22 wherein the nonlinear fiber has a nonlinear index coefficient of about 10⁻¹⁴ m²/Watt at a mode field diameter of 100 μm and an input power to the nonlinear fiber of 10 m Watt.

27. An optical transmission system for communicating a signal comprising:
an optical transmitter having a transmitter input for inputting the signal, a transmitter output and a distributed feedback laser diode for signal conversion;
a nonlinear material coupled to the transmitter output for compensating for signal distortions, wherein the nonlinear material being anti-reflection coated;
at least two variable optical attenuators for power adjustment in the transmission system, the at least two variable optical attenuators being coupled to the nonlinear material; and
a transmission fiber coupled to one of the at least two variable optical attenuators, the transmission fiber for communicating the signal to an optical receiver.

28. An optical transmission system for simultaneously communicating a plurality of signals comprising:
a plurality of optical transmitters, each of the plurality of optical transmitters having one of a plurality of transmitter inputs for inputting one of the plurality of signals, one of a plurality of transmitter outputs and one of a plurality of laser diodes for signal conversion, wherein each of the plurality of optical transmitters is coupled to one of a plurality of nonlinear materials for compensating for signal distortions;
a multiplexer coupled to the plurality of nonlinear materials for multiplexing the plurality of signals into a multiplexed signal;
a transmission fiber coupled the multiplexer for communicating the multiplexed signal to a de-multiplexer, the de-multiplexer having a plurality of de-multiplexer outputs for outputting a plurality of de-multiplexed signals; and
a plurality of optical receivers, each of the plurality of optical receivers coupled to one of the plurality of de-multiplexer outputs for receiving one of the plurality of de-multiplexed signals.

29. The optical transmission system of claim 28 further comprising a plurality of variable optical attenuators wherein at least one of the plurality of variable optical attenuators is coupled to at least one of the plurality of nonlinear materials.

30. The optical transmission system of claim 28 wherein at least one of the plurality of nonlinear materials is a nonlinear fiber.

31. The optical transmission system of claim 30 wherein the nonlinear fiber has a nonlinear index coefficient of about 10⁻¹⁴ m²/Watt.

32. The optical transmission system of claim 28 wherein at least one of the plurality of nonlinear materials is a nonlinear film.

33. The optical transmission system of claim 32 wherein the nonlinear film has a nonlinear index coefficient of about 10⁻¹⁰ m²/Watt.

34. The optical transmission system of claim 28 wherein at least one of the plurality of nonlinear materials is a nonlinear bulk structure.

35. The optical transmission system of claim 34 wherein the nonlinear bulk structure has a nonlinear index coefficient of about 10⁻¹⁰ m²/Watt.

36. The optical transmission system of claim 28 wherein at least one of the plurality of nonlinear materials is a nonlinear waveguide.

37. The optical transmission system of claim 36 wherein the nonlinear waveguide has a nonlinear index coefficient between 10⁻¹² m²/Watt and 10⁻¹⁰ m²/Watt.

38. The optical transmission system of claim 28 wherein the plurality of nonlinear materials is a plurality of nonlinear fibers.

39. The optical transmission system of claim 38 wherein each of the plurality of nonlinear fibers has a nonlinear index coefficient of about 10⁻¹⁴ m²/Watt.

40. The optical transmission system of claim 28 wherein the plurality of nonlinear materials is a plurality of nonlinear films.

41. The optical transmission system of claim 40 wherein each of the plurality of nonlinear films has a nonlinear index coefficient of about 10⁻¹⁰ m²/Watt.

42. The optical transmission system of claim 28 wherein the plurality of nonlinear materials is a plurality of nonlinear bulk structures.

43. The optical transmission system of claim 42 wherein each of the plurality of nonlinear bulk structures has a nonlinear index coefficient of about 10⁻¹⁰ m²/Watt.

44. The optical transmission system of claim 28 wherein the plurality of nonlinear materials is a plurality of nonlinear waveguides.

45. The optical transmission system of claim 44 wherein each of the plurality of nonlinear waveguides has a nonlinear index coefficient between 10⁻¹² m²/Watt and 10⁻¹⁰ m²/Watt.

46. The optical transmission system of claim 28 wherein at least one of the plurality of nonlinear materials is anti-reflection coated.

47. The optical transmission system of claim 28 wherein the plurality of nonlinear materials are anti-reflection coated.

48. The optical transmission system of claim 28 wherein at least one of the plurality of laser diodes is a distributed feedback laser diode.

49. The optical transmission system of claim 28 wherein the plurality of laser diodes is a plurality of distributed feedback laser diodes.

50. The optical transmission system of claim 28 wherein each of the plurality of optical transmitters includes an external modulator for signal modulation.

51. The optical transmission system of claim 27 wherein the optical transmitter includes an external modulator for signal modulation.

52. A method for transmitting a plurality of input signals comprising:
generating the plurality of input signals;
compensating signal distortion by passing each of the plurality of input signals through each of a plurality of nonlinear materials, the quantity of the plurality of input signals equaling the quantity of the plurality of nonlinear materials;
after signal distortion compensation, multiplexing the plurality of input signals into a multiplexed signal and transmitting the multiplexed signal to a de-multiplexer;
de-multiplexing the multiplexed signal into a plurality of de-multiplexed signals, the plurality of de-multiplexed signals corresponding to the plurality of input signals on a one-to-one basis.

53. The method of claim 52 further comprising receiving the plurality of de-multiplexed signals.

54. The method of claim 52 wherein each of the plurality of nonlinear materials has a nonlinear index coefficient of about 10⁻¹⁰ m²/Watt.

55. The method of claim 52 wherein each of the plurality of nonlinear materials has a nonlinear index coefficient of about 10⁻¹² m²/Watt.

56. The method of claim 52 wherein each of the plurality of nonlinear materials has a nonlinear index coefficient of about 10⁻¹⁴ m²/Watt.
